(19) United States
(12) Patent Application Publication
(10) Pub. No.: US 2022/0284518 A1
(43) Pub. Date: Sep. 8, 2022

(54) Investment Management System and Method

(71) Applicants: Ryan Mullaney, Sauk Centre, MN (US); Eric Christenson, Maple Grove, MN (US)

(72) Inventors: Ryan Mullaney, Sauk Centre, MN (US); Eric Christenson, Maple Grove, MN (US)

(21) Appl. No.: 17/230,218

(22) Filed: Apr. 14, 2021

Related U.S. Application Data
(60) Provisional application No. 63/155,493, filed on Mar. 2, 2021.

(51) Int. Cl. G06Q 40/00; G06Q 40/06

(52) U.S. Cl. CPC G06Q 40/10; G06Q 40/06; G06Q 40/123

(57) ABSTRACT

A system and method for managing tax consequences associated with financial market transactions. The tax management system comprises a platform access component hosted by a computer and accessible via a user input device. The tax management system allows a user to set aside and internally or externally transfer a determined amount of money related to the sale of an investment asset. The amount set aside may be determined by percentage or preset dollar amount. When an investor sells a stock or other security for a profit, a percentage of the profits representing the tax liability from the sale is moved a separate account. The tax management system allows the user to set aside a percentage of profits, cash amount per transaction, percentage of total sale, or percentage of a portion of each sale automatically to a separate account administered by the tax management system.

### CROSS-REFERENCE TO RELATED APPLICATION

The present application claims priority to, and the benefit of, U.S. Provisional Application No. 63/155,493, which was filed on Mar. 2, 2021 and is incorporated herein by reference in its entirety.

### FIELD OF THE INVENTION

The present invention relates generally to the field of financial planning. More specifically, the present invention relates to a digital application designed to set aside and internally or externally transfer a determined amount of money. Accordingly, this disclosure makes specific reference thereto the present invention. Nonetheless, it is to be appreciated that aspects of the present invention are also equally applicable to other like applications, devices and methods of manufacture.

### BACKGROUND

By way of background, people around the world invest in stocks and more. Stocks can be a valuable part of the investment portfolio of the individuals. People owning stocks in different companies can help them to build their savings, protect their money from inflation and taxes, and maximize their income from investments. However, with these advantages, people may have to face the risks while investing in the stock market. In case the stock market is down, people may suffer losses as well.

People with multiple financial accounts, portfolios, and investments may be unprepared when tax season occurs, and may not be able to pay the required taxes. Also, it may be difficult for the individuals to manage the profits and losses in multiple financial accounts, portfolios, and investments. People may be unable to pay taxes due to lack of required savings or funds during the tax payment cycle. People may have to sell their stocks to pay the taxes losing out on potential gains. Even worse, if the stock market is down, then the person has to bear the loss due to stock sale exacerbating losses.

Additionally, people who trade using borrowed money have no real idea of the actual value of the account at any given time. The tax implications of multiple trades may be difficult to identify and prepare for when trading short term. When the person is faced with an unanticipated tax burden from trading, they are forced to find additional funding to pay off the taxes and do not realize the full benefits of the trades.

Therefore, there exists a long felt need in the art for an investing tool which enables the users to better manage their funds. There is also a long felt need in the art for an investing tool that helps the individuals in preparing for tax consequences before the tax season arrives. Additionally, there is a long felt need in the art for an investing tool that enables the users to manage their funds and for the accommodation of losses. Further, there is a long felt need in the art for an investing tool which allows individuals to manage multiple financial accounts, portfolios, investments, and the like. Finally, there is a long felt need in the art for an investing tool that helps users avoid having to selling stocks for tax payment.

In this manner, the novel investing tool of the present invention accomplishes all of the forgoing objectives, and provides a relatively easy, convenient and efficient solution to prepare users for payment of taxes when making investing trades. The investing tool of the present invention is user friendly, as it prepares users to manage investment trading consequences. The investing tool allow users to easily manage multiple financial accounts, portfolios, investments and the like.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a tax consequence management system. The tax consequence management system is configured to manage a flow of transactions and manage an associated tax liability related to a sale of a plurality of investment assets. The tax management system is remotely accessible over the Internet via a user input, such as a mobile electronic device or a computer.

The tax consequence management system comprises a platform host. The platform host comprises a memory and at least one processor. The at least one processor is operatively connected to the user input via a network, program, or code. The memory comprises a non-transitory computer-readable medium comprising a set of software instructions, extrapolation, or process. The set of software instructions comprises a tax management function stored on the server, computer, program, code, or application in the memory.

The tax management platform is configured to access an associated investing account. The associated investing account may be a brokerage or other asset trading account. The tax management function is further configured to access a tax holding account. The tax holding account may be a bank account or other financial account that is separate from the associated investing account. The tax management function is further configured to link the tax holding account to the associated investing account.

When a user sells an investment asset, such as a security, a tax liability may be triggered. The tax management function calculates a tax liability related to the sale of the investment asset and transfers an amount equal to the tax liability amount from the associated investing account to the tax holding account. The tax management platform is further configured to provide information related to the sale of the investment asset and the tax liability amount. The information is accessible on the tax management function's display via the user input device.

In the event that the investment asset is sold at a loss, a capital tax loss may be triggered. The tax management platform is further configured to calculate a capital tax loss amount related to the sale of the investment asset in the associated investing account. Then the tax management function is further configured to transfer an amount equal to the capital tax loss from the tax holding account to the associated investing account.

The subject matter disclosed and claimed herein, in one embodiment thereof, comprises a method of maintaining a tax liability using a tax management platform accessible via a user input operatively connected to the tax management platform over a network. The method comprises the steps of connecting an associated investing account to the tax management function. Next, a tax holding account receives funds transferred from the investment account for a sum determined by the tax management function. The tax holding account is linked to the associated investing account. On the sale of an investment asset in the associated investing account, a tax liability is predicted by the tax management function. Then an amount equal to the tax liability for the sale of the investment asset is transferred from the associated investing account to the tax holding account.

The method further comprises the steps of providing information on the tax management platform related to the sale of the investment and the tax liability. In the event that the investment asset is sold at a loss, the tax management platform predicts a capital tax loss amount related to the sale. Then the tax management platform transfers an amount equal to the capital tax loss from the tax holding account to the associated investing account. If the tax management function has a negative balance the tax management function will not transfer any money from investment sales until there are estimated taxes due.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a schematic view of a tax consequence management system of the present invention in accordance with the disclosed architecture;

FIG. 2 illustrates a schematic view of a tax management platform of the tax consequence management system of the present invention in accordance with the disclosed architecture;

FIG. 3 illustrates a flowchart of a method of maintaining a tax liability using the tax management platform of the tax consequence management system of the present invention in accordance with the disclosed architecture; and

FIG. 4 illustrates a flowchart of a method of a flow of transactions of the when using the tax consequence management system of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long felt need in the art for an investing tool which enables the users to manage their investment funds. There is also a long felt need in the art for an investing tool that helps the individuals in preparing for tax payment even before the tax season arrives. Additionally, there is a long felt need in the art for an investing software that enables the users to manage their funds for tax payment and for the accommodation of losses. Further, there is a long felt need in the art for an investing tool which makes the people aware of their trading funds and tax consequences and helps them easily manage multiple financial accounts, portfolios, investments, and the like. Finally, there is a long felt need in the art for an investing tool that helps users avoid having to sell stocks to cover their taxes on trading.

The present invention, in one exemplary embodiment, is a novel method for a stock sale splitting of funds using an investment management software. The investment management software is designed to set aside and internally transfer a determined amount of money into a separate fund, account, bank, credit card. The investment management software is executed by a processor, code, application, so as to cause the processor, code, or application to implement the steps of associating a separate financial holding account on an investment platform for keeping a profit of stock sell of an investor, determining a percentage of profit of stock sell to move to the separate financial holding account, redirecting amount corresponding to the determined percentage of the profit to the separate financial holding account when the stock sale is executed, and storing funds intended for paying taxes of the investor using the separate financial holding account. In place of a separate financial holding account, any secure and separate fund, charity, person, credit card may be used for redirecting the determined percentage of the profit on which an interest can be earned by investment platforms.

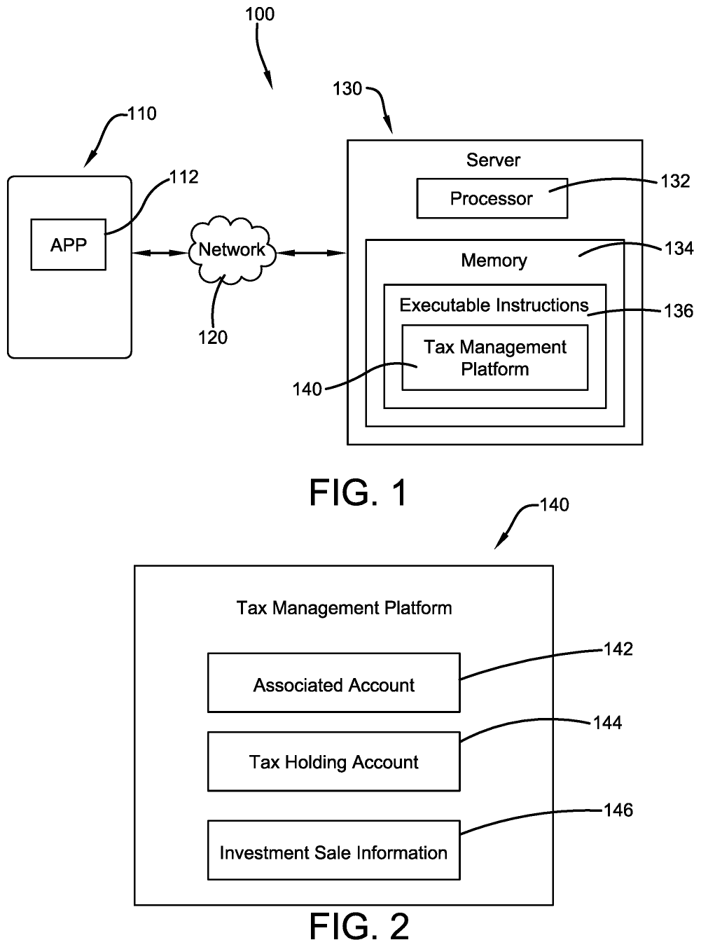

Referring initially to the drawings, FIG. 1 illustrates a tax consequence management system 100. The tax consequence management system 100 is configured to manage a flow of transactions and manage an associated tax liability related to a sale of investment assets by setting aside a predetermined amount of funds for tax payments related to the transactions. The tax management system 100 is remotely accessible over the Internet via a user input 110 using a mobile or computer application 112. The application 112 allows the user input 110 to perform methods of the present technology when executed. The user input 110 may be a mobile electronic device or other internet connectable user input, such as a smart phone, an electronic pad, a computer, a smart watch, a digital assistant, or any other internet connected electronic communication device.

The tax consequence management system 100 comprises a platform host 130. The platform host 130 is a functionality and comprises a memory 134 and at least one processor 132. The at least one processor 132 is operatively connected to the user input 110 via a communications network 120. The memory 134 comprises a non-transitory computer-readable medium comprising a set of software instructions 136 executable by the processor 132. The set of software instructions 136 comprises a tax management platform 140 stored on the platform host 130 in the memory 134 and accessible by a processing system of the user input 110. The platform host 130 is typically a remote server installed in a computer system accessible via the processor 132. The server can be located anywhere, such as locally in a data center or in a public cloud.

The communications network 120 may be any of a number of private or public communications mechanisms such as the Internet, a local intranet, a Personal Area Network, a Local Area Network, a Wide Area Network, a Virtual Private Network, or the like. When one of the user inputs 110 is connected to the platform host 130 via the network 120, the tax management platform 140 allows the platform host 130 to perform methods of the present technology when executed by the processor 132.

As illustrated in FIG. 2, the tax management platform 140 is configured to access or upload an associated investing account 142. The associated investing account 142 may be a brokerage, retirement, or other asset trading account that is uploaded to the tax management platform 140. The tax management platform 140 is further configured to access or upload a tax holding account 144. The tax holding account 144 may be a bank account, a separate fund account, or other financial account that is separate from the associated investing account 142. The tax management platform 140 is further configured to link the tax holding account 144 to the associated investing account 142.

When a user sells an investment asset, such as a stock, a bond, or other security, a tax liability is triggered. The tax management platform 140 calculates or predicts a tax liability related to the sale of the investment asset. The tax management platform 140 then transfers an amount equal to the tax liability amount from the associated investing account 142 to the tax holding account 144. The tax management platform 140 is further configured to provide an investment sale information component 146. The investment sale information component 146 provides information related to the sale of the investment assets and the tax liability amount. The information is accessible on the tax management platform 140 via the user input device 110. The tax liability balance can be updated, changed, or customized by the investor.

In the event that the investment asset is sold at a loss, a capital tax loss calculation is triggered. The tax management platform 140 is further configured to calculate a capital tax loss amount related to the sale of the investment asset in the associated investing account. Then the tax management platform 140 is further configured not to withhold any profits until the estimated tax implications are greater than zero.

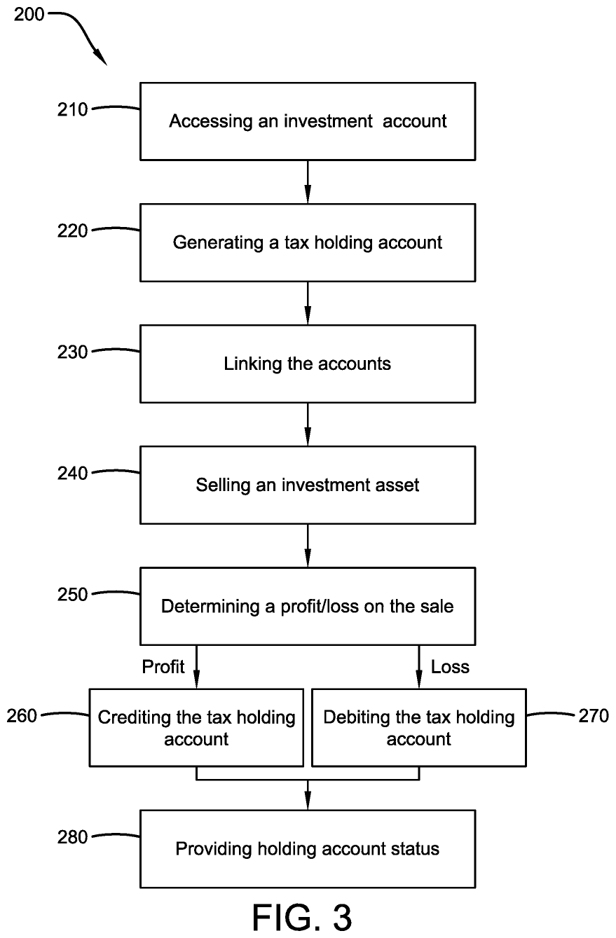

As illustrated in FIG. 3, the subject matter disclosed and claimed herein, in one embodiment thereof, comprises a method 200 of maintaining a tax liability using a tax management platform 140 accessible via a user input 110, such as a mobile electronic device or computer, operatively connected to the tax management platform 140 over a network 120. The user input 110 may be a mobile electronic device or other internet connectable user input.

The method 200 comprises the steps of uploading or accessing an associated investing account 142 to the tax management platform 140 at 210. Next, at 220 a tax holding account 144 is uploaded to or generated on the tax management platform 140. The tax holding account 144 is linked to the associated investing account 142 at 230. On the sale of an investment asset, such as a security, in the associated investing account 142 at 240, a profit or loss is determined at 250. If the asset was sold at a profit, at a tax liability is predicted. Then an amount equal to the tax liability for the sale of the investment asset is transferred from the associated investing account 142 to the tax holding account 144 at 260

In the event that the investment asset is sold at a loss, the tax management platform 140 predicts a capital tax loss amount related to the sale. Then the tax management platform 140 then transfers an amount equal to the capital tax loss from the tax holding account 144 to the associated investing account 142 at 270. If the estimated tax implications are less than zero, meaning negative, the tax management function will not extract profits from sales until the estimated tax implication of the annual sales are greater than zero. The method 200 further comprises the step of providing information on the tax management function related to the sale of the investment and the tax liability at 280. The advantage of the separate tax holding account 144 is that the balance is not reflected in available balance of the associated investing account 142 so that the investor is not able to use the amount and is kept safe for tax payment. This helps investors prepare for paying taxes and helps the tax holding account 144 earn interest while safely set aside.

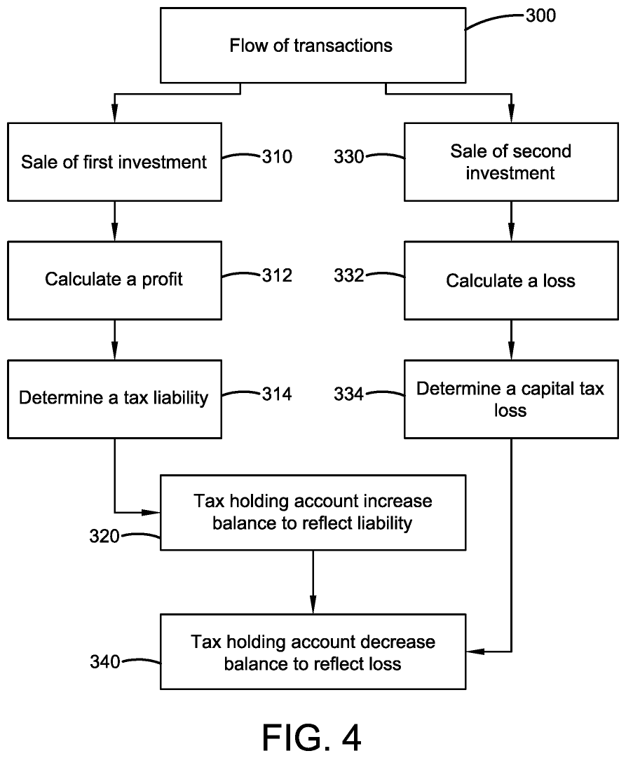

FIG. 4 illustrates an exemplary flow of transactions 300 when using the tax consequence management system 100. A sale of a first investment asset at 310 triggers a profit. At 312, the tax management platform 140 calculates a profit from the sale. Then at 314, the tax management platform 140 determines a tax liability. At 320 the tax management platform 140 credits the tax holding account 144 with funds from the sale taken from the associated investing account 142.

At 330, a sale of a second investment asset triggers a loss. At 332, the tax management platform 140 calculates a loss from the sale. Then at 334, the tax management platform 140 determines a capital tax loss. At 340 the tax management platform 140 debits the tax holding account 144 with funds previously withheld and credits the associated investing account 142.

The tax consequence management system 100 allows investors to automatically redirect a percentage of profits, cash amount per transaction, percentage of total sale, or percentage of a portion of each sale automatically. The tax consequence management system 100 further allows users to earn interest on banked funds in the separate accounts. The purpose of this transfer of funds into a separate account is to help investors prepare for paying taxes and to help investments bank more money to better prepare fore and avoid unintended tax consequences.

The term “computer-readable medium” as used herein refers to any medium that participates in providing instructions to processor for execution. Such a medium may take many forms, including but not limited to, non-volatile media, volatile media, and transmission media. Non-volatile media includes, for example, optical or magnetic disks, such as storage device. Volatile media includes dynamic memory, such as main memory.

Notwithstanding the forgoing, the tax consequence management system 110 and the method 200 of the present invention can include any additional component to enhance the functionality and efficiency of the tax consequence management system 110 and the method 200. One of ordinary skill in the art will appreciate that the configuration, components of the tax consequence management system 110 and the method 200 as shown in the FIGS. are for illustrative purposes only, and that many other configuration and components are well within the scope of the present disclosure.

The present invention can be included in an article of manufacture (e.g., one or more computer program products) having, for instance, computer useable media. The media has embodied therein, for instance, computer readable program code means for providing and facilitating the mechanisms of the present invention. The article of manufacture can be included as part of a computer system or sold separately.

The present invention may be implemented with any combination of hardware and software. If implemented as a computer-implemented apparatus, the present invention is implemented using means for performing all of the steps and functions described in the present disclosure.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A tax consequence management system accessible via a user input, the tax consequence management system comprising:
a functionality comprising a computer-based tax management platform and at least one processor operatively connected to the user input via a network; and
wherein the tax management platform is configured to:
access an associated investing account;
link a tax holding account to the associated investing account;
predict a tax liability amount related to a sale of an investment asset in the associated investing account;
automatically transfer an amount equal to the predicted tax liability amount from the associated investing account to the tax holding account; and
predict a capital tax loss amount related to a sale of the investment asset in the associated investing account; and
wherein the tax management platform is further configured to not make a transfer from the tax holding account to the associated investing account unless a tax implication for total profits related to a sale of the investment asset are estimated to be greater than zero.

2. The tax consequence management system of claim 1, wherein the user input is a mobile electronic device.

3. The tax consequence management system of claim 1, wherein the associated investing account is a brokerage account.

4. The tax consequence management system of claim 1, wherein the investment asset is a security.

5. The tax consequence management system of claim 1, wherein the tax management platform is further configured to provide information related to the sale of the investment asset.

6. The tax consequence management system of claim 1, wherein the tax management platform is further configured to provide information related to the tax liability amount.

7. (canceled)

8. (canceled)

9. The tax consequence management system of claim 1, wherein the platform host is a remote server.

10. A non-transitory computer-readable medium comprising software instructions that, when executed by at least one processor, causes the processor to:
access a tax management platform of a computer-based system;
communicate and extrapolate data from an associated investing account to the tax management platform;
upload a tax holding account to the tax management platform;
link the tax holding account to the associated investing account;
predict a tax liability for a sale of an investment asset; and
automatically transfer an amount equal to the tax liability for the sale of the investment asset from the associated investing account to the tax holding account.

11. The non-transitory computer-readable medium of claim 10, wherein the associated investing account is a brokerage account.

12. The non-transitory computer-readable medium of claim 10, wherein the tax holding account is a bank account.

13. The non-transitory computer-readable medium of claim 10, wherein the at least one processor is a processing system of a mobile electronic device.

14. The non-transitory computer-readable medium of claim 10, wherein the tax management platform is configured to provide information related to the sale of the investment asset.

15. The non-transitory computer-readable medium of claim 10, wherein the tax management platform is configured to provide information related a tax liability or a capital tax loss from the sale of the investment asset.

16. A method of maintaining a tax liability using a tax management platform on a computer-based system accessible via a user input operatively connected to the tax management platform over a network comprising the steps of:
uploading an associated investing account to the tax management platform;
uploading a tax holding account to the tax management platform;
linking the tax holding account to the associated investing account;
predicting a tax liability for a sale of an investment asset in the associated investing account;
transferring an amount equal to the tax liability for the sale of the investment asset from the associated investing account to the tax holding account automatically; and
automatically rebating an amount from the tax holding account to the associated investing account equal to a capital tax loss from the sale of the investment asset.

17. The method of claim 17 further comprising the step of providing information on the tax management platform related to the sale of the investment and the tax liability.

18. (canceled)

19. The method of claim 17, wherein the investment asset is a security.

20. The method of claim 17, wherein the user input is a mobile electronic device.
